(19) United States
(12) Patent Application Publication
(10) Pub. No.: US 2005/0160038 A1
(43) Pub. Date: Jul. 21, 2005

(54) Prompted automatic online payments

(75) Inventor: Jordi Albornoz, Arlington, MA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/759,966

(22) Filed: Jan. 16, 2004

(51) Int. Cl. G06F 17/60

(52) U.S. Cl. 705/42

(57) ABSTRACT

A system, method and computer program product are disclosed for providing automatic recurring online payments. According to the method, an automatic recurring online payment configuration is received from a user. A notification is sent to the user of a pending automatic payment based on the automatic recurring online payment configuration, and it is determined whether or not to execute the pending automatic payment based on at least one of a response to the notification received from the user and a lack of a response to the notification from the user. In one embodiment, if the response authorizes the pending automatic payment, the pending automatic payment is executed according to the automatic recurring online payment configuration, if the response modifies the pending automatic payment, the pending automatic payment is executed as modified, and if the response cancels the pending automatic payment, the automatic recurring online payment is canceled.

### BACKGROUND OF THE INVENTION

1. Field of the Invention

This invention generally relates to the field of online banking and more specifically to automatic online payments.

2. Description of Related Art

Consumers commonly use online banking systems to manage their funds. Online banking systems often provide the user with a method for paying bills electronically, i.e., online payments. Consumers typically have multiple bills that occur repeatedly. For instance, mortgages are typically billed monthly at the same amount. For convenience, many of the current online banking systems provide the ability for consumers to set up automatically recurring electronic payments, i.e., automatic recurring online payments. A user typically provides an amount and an interval for the automatic recurring online payment.

Such automatic payment systems have become important for banks not only as a means for providing enhanced functionality to their customers, but also for reducing their costs. Online payments are less costly to process than traditional payments such as checks. However, many consumers feel that such automatic payment systems require yielding too much control of their funds. Automatic recurring online payments simply happen at a particular date even in the case of special circumstances, such as a lack of funds. Thus, some consumers consider the automatic payment systems risky and do not create automatic recurring online payments. Consumers feel more at risk of mistakenly having insufficient funds in their accounts at the time an automatic recurring online payment is made. The fundamental convenience that automatic recurring online payments offer, that the user can essentially forget about the payments, is also the fundamental barrier to adoption since users are forced to still consider these payments to avoid overdraft.

Additionally, there currently is an automatic payment system located at www.paymybills.com, which is operated by PayTrust, Inc. This system receives the bills and sends a notification whenever a bill arrives and to allow a user to pay the bill quickly. This system even ensures a user's account balance is sufficient before allowing payment. This system, however, requires that a bill is received in order to prompt a payment of the bill. Thus, this system requires that bills are sent to the automatic payment system in order to prompt a payment of the bill. This reduces privacy and adds cost. Another drawback of this system is that automatic recurring online payments cannot be created and configured by the user.

Therefore a need exists to overcome the problems discussed above, and particularly for a way to more efficiently provide automatic online payments to consumers.

### SUMMARY OF THE INVENTION

Briefly, in accordance with the present invention, disclosed is a system, method and computer program product for providing automatic recurring online payments. In a method according to a preferred embodiment of the present invention, an automatic recurring online payment configuration is received from a user. A notification is sent to the user of a pending automatic payment based on the automatic recurring online payment configuration, and it is determined whether or not to execute the pending automatic payment based on a response to the notification received from the user and/or based on a lack of a response to the notification from the user. In one embodiment, if the response authorizes the pending automatic payment, the pending automatic payment is executed according to the automatic recurring online payment configuration, if the response modifies the pending automatic payment, the pending automatic payment is executed as modified, and if the response cancels the pending automatic payment, the automatic recurring online payment is canceled.

Also disclosed is a computer system for providing automatic recurring online payments. In one embodiment, the computer system includes a receiver that receives from a user an automatic recurring online payment configuration, and a transmitter that sends a notification to the user of a pending automatic payment based on the automatic recurring online payment configuration. The computer system also includes a processor that determines whether or not to execute the pending automatic payment based on a response to the notification received from the user and/or based on a lack of a response to the notification from the user.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is a flowchart depicting the overall operation and control flow of a conventional automatic online payment system.

FIG. 3 is a flowchart depicting the overall operation and control flow of one embodiment of the present invention.

FIG. 4 is a flowchart depicting the operation and control flow of the verification process of one embodiment of the present invention.

FIG. 5 is a screenshot of an exemplary user interface for configuring a recurring automatic online payment.

FIG. 6 is a screenshot of an exemplary user interface for viewing a notification of a recurring automatic online payment.

FIG. 7 is a block diagram of a computer system useful for implementing the present invention.

### DESCRIPTION OF THE PREFERRED EMBODIMENTS

1. Introduction

The present invention, according to a preferred embodiment, overcomes problems with the prior art by providing an efficient and easy-to-implement method for providing prompted automatic recurring online payments.

In the automatic recurring online payment process of the preferred embodiment, instead of immediately sending a payment when it is scheduled to be sent an electronic notification (such as an email, voice mail, text message, instant message or the like) is first sent asking for confirmation or verification of the payment. When a user sees the notification, a payment can be verified or canceled by, for example, logging onto the banking system and issuing a command.

One advantage of the present invention is the convenience of having the banking system remember recurring payments each month. Another advantage of the present invention is that control is maintained by the user as well. The user can easily cancel or verify a payment. The system of the present invention can be set up so that a payment is either automatically canceled or automatically verified if no response is received from the user after a predetermined time has passed.

The preferred embodiment of the present invention can be implemented by adding the option of verification to current online banking payment systems. Present online banking payment systems may, for example, add the functionality of sending to a user an email notification with a link to a payment confirmation Web page. The user can then visit the Web page to confirm the payment. Proper authentication would be required before the user authorizes the payment. In another example, the user may send an encrypted reply to the notification email wherein the reply specifies confirmation or cancellation of the payment for the given month. The response to the notification preferably may also modify the payment amount for the given month.

In one embodiment of the present invention, a user, or payer, can set up a recurring automatic online payment to a payee, where the payer is prompted for approval each time a payment is to be sent to the payee as part of the recurring payment. The recurring automatic online payment can include, for example, an amount to pay and an interval between each payment. Instead of sending the payment immediately to the payee when the interval for a payment is reached, a notification is sent to the payer for the pending payment. The payer has the option of canceling the pending payment, allowing it to proceed or modifying it.

In one embodiment of the present invention, the user creates a recurring automatic online payment via a user interface such as a Web browser or an automated voice response system. The user is prompted to provide information pertaining to the payee. This information may come from a database of payee information, may be automatically determined by having received a bill creation request from a payee, or may be manually input by the payer. The user is also prompted for the amount of each recurring automatic online payment.

In one alternative, the recurring automatic online payment information may be automatically determined by having received a bill creation request from a payee. The payment amount may adjust between actual payments of the recurring payment order. The user is also prompted for the time interval between each payment. This time interval may be entered manually or may be automatically determined via a bill creation request. The user submits this information as well as any other information that may be needed to complete a payment (such as passwords and account numbers). This information is submitted into a database of recurring payments for the user. The system then actively waits for the time interval to pass.

When the interval has passed and it comes time to make a recurring automatic online payment, the user is sent a notification of imminent payment. This notification can be sent using a bi-directional communication medium, such as email, such that the payer may respond to the notification with instructions to either proceed with the payment, suspend the payment, modify the payment or cancel the payment all together. In one alternative, the user may respond with a variety of instructions such as moving money between accounts, delaying the payment, modifying the amount of the payment, etc.

In one example, the present invention may send a notification via email, which contains a URL (Uniform Resource Locator). This URL leads the user, via a Web browser, to a web page where the user may, after supplying security credentials, perform the appropriate actions to allow, cancel, suspend or modify the payment. In another example, the user may reply to the notification email message and indicate his instructions in the reply text of the email. Authentication in such an implementation can be done using digital signatures.

2. Overview of the System

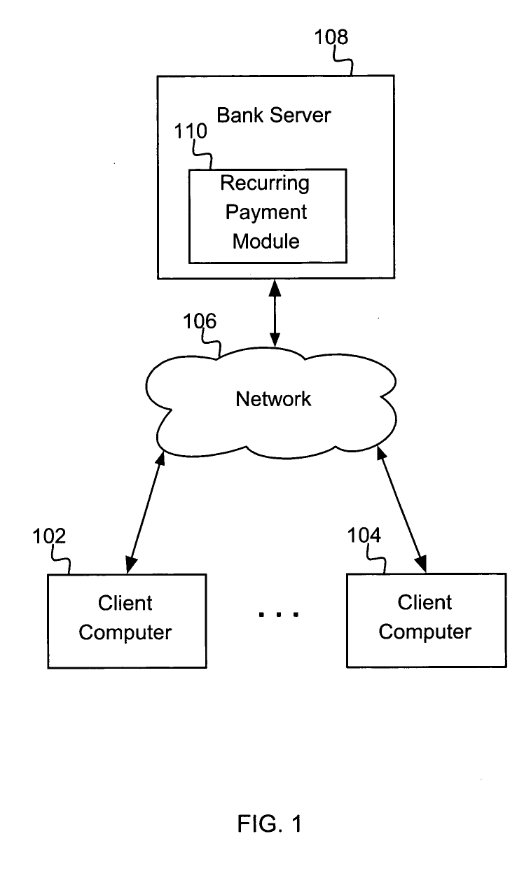

FIG. 1 is a block diagram illustrating the overall system architecture of one embodiment of the present invention. FIG. 1 shows client computers 102 and 104 operated by users. FIG. 1 also shows bank server 108, which provides banking services to the client computers 102 and 104 over a network 106. A recurring payment module 110, which resides within the bank server 108 and is described in greater detail below, encompasses the functions of processing and executing recurring automatic online payments. The bank server 108 comprises any commercially available server system that allows client computers 102 and 104 to exist in a client-server relationship with the bank server 108.

In one embodiment of the present invention, the computer systems of client computers 102 and 104 and bank server 108 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of at least one of client computers 102 and 104 and bank server 108 are a server system (e.g., SUN Ultra workstations running the SunOS operating system or IBM RS/6000 workstations and servers running the AIX operating system). In one embodiment of the present invention, the network 106 is a circuit switched network, such as the Public Service Telephone Network (PSTN). In another embodiment, the network is a packet switched network. The packet switched network is a wide area network (WAN), such as the global Internet, a private WAN, a local area network (LAN), a telecommunications network or any combination of the above-mentioned networks. In yet another embodiment, the network is a wired network, a wireless network, a broadcast network or a point-to-point network.

Although bank server 108 and recurring payment module 110 are shown as integrated entities in FIG. 1, the functions of both entities may be separated among more than one entity. Further, although FIG. 1 shows two client computers 102 and 104, the present invention supports any number of client computers.

3. The Conventional Process

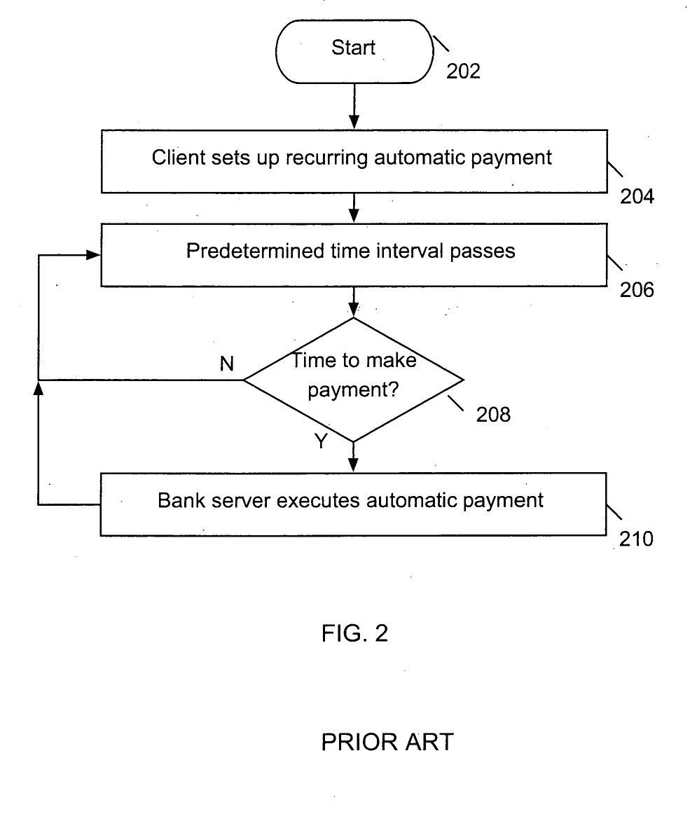

FIG. 2 is a flowchart depicting the overall operation and control flow of a conventional automatic online payment system. The operation and control flow of FIG. 2 depicts the overall processes of a conventional automatic online payment system as it processes and executes a recurring automatic online payment. The operation and control flow of FIG. 2 begins with step 202 and proceeds directly to step 204.

In step 204, a user utilizing a client computer, such as client computer 102, sets up or configures an automatic recurring online payment. Configuring an automatic recurring online payment includes providing a set of information pertaining to the automatic recurring online payment, such as a monetary amount, a source account of the payment, a recipient or payee of the payment, a date of the payment, a time interval between payments, and a monthly date for the payment.

In step 206, a predetermined time interval, such as a day or a week, is allowed to pass. In step 208, it is determined whether the current date is an appropriate date for executing the automatic recurring online payment that was configured in step 204. If the current date is an appropriate date for executing the automatic recurring online payment that was configured in step 204, then control flows to step 210. If the current date is not an appropriate date for executing the automatic recurring online payment, then control flows back to step 206 where another time interval is allowed to pass before step 208 is executed again. In step 210, the bank server executes the automatic recurring online payment that was configured in step 204. Consequently, control flows back to step 206 where another time interval is allowed to pass before step 208 is executed again.

4. Prompted Automatic Payments

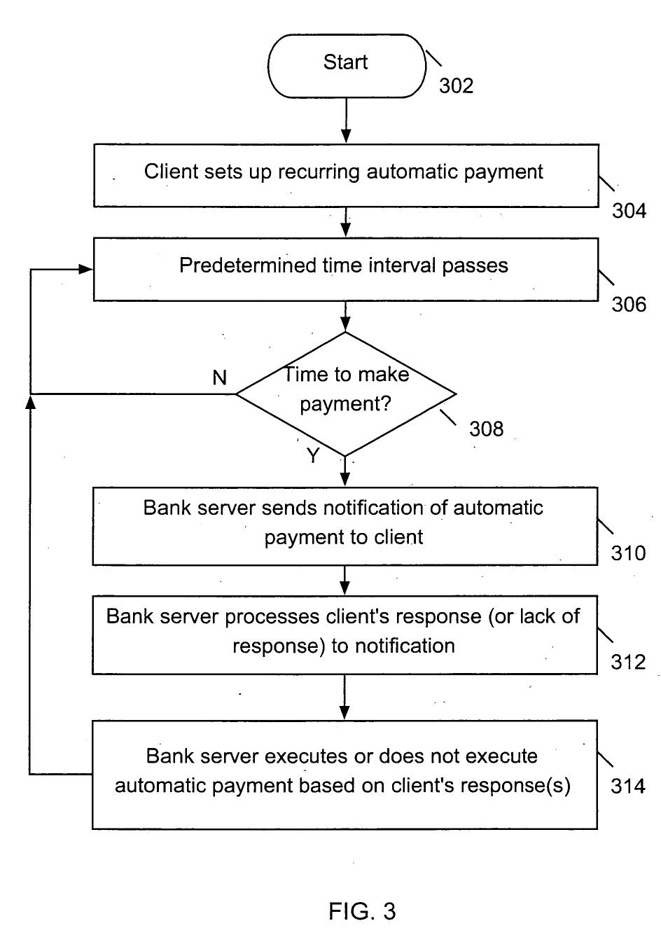

FIG. 3 is a flowchart depicting the overall operation and control flow of one embodiment of the present invention. The operation and control flow of FIG. 3 begins with step 302 and proceeds directly to step 304.

In step 304, a user utilizing a client computer, such as client computer 102, sets up or configures an automatic recurring online payment with the bank server 108. Configuring an automatic recurring online payment includes providing a set of information pertaining to the automatic recurring online payment, such as a monetary amount, a source account of the payment, a recipient or payee of the payment, a date of the payment, a time interval between payments, and a monthly date for the payment.

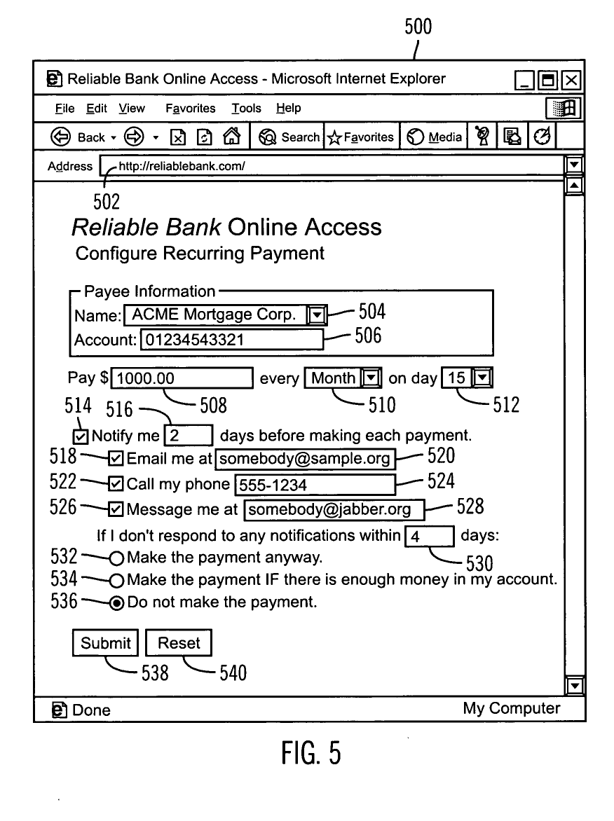

The user may accomplish the task of configuring an automatic recurring online payment in a variety of ways. One way of accomplishing this task is for the user to interact with a user interface of the bank server 108, such as through a Web browser. A Web browser configured for this task is described in more detail with reference to FIG. 5. Another way of accomplishing this task is for the user to send the automatic recurring online payment to the bank server 108 via email or another method.

Alternatively, the task of configuring an automatic recurring online payment can be performed by sending the automatic recurring online payment information to the bank server 108 in a variety of ways including email, instant messaging, File Transfer Protocol (FTP), Hypertext Transfer Protocol (HTTP) or any other method for sending and receiving information over a network. In another alternative, the information is sent over a connection between the client computer 102 and the bank server 108. Such a connection can be a Virtual Private Network (VPN) connection, a Transfer Control Protocol/Internet Protocol (TCP/IP) connection or any other network connection.

In addition to configuring an automatic recurring online payment, in step 204, the user may also configure other aspects of the payment system. For example, the user may configure the manner in which to notify the user (e.g., via email, instant message, telephone message or text message), how many days before the scheduled payment the notification should be sent out, how long to wait for a response from the user and the default action that should be taken if the user does not respond (e.g., cancel the payment, suspend the payment for a certain number of payments, make the payment or make the payment only if there are sufficient funds to cover the payment).

In step 306, a predetermined time interval, such as a day or a week, is allowed to pass. In step 308, it is determined whether the current date is an appropriate date for executing the automatic recurring online payment that was configured in step 304. If the current date is an appropriate date for executing the automatic recurring online payment that was configured in step 304, then control flows to step 310. If the current date is not an appropriate date for executing the automatic recurring online payment, then control flows back to step 306 where another time interval is allowed to pass before step 308 is executed again.

In step 310, the bank server 108 sends a notification of the automatic recurring online payment to the user. As explained above, the notification may be an email, an instant message, a telephone message or a text message. The notification may include a variety of information such as a current account balance, an amount of the payment, a source account of the payment, a recipient of the payment and a date of the payment. The notification may also include an explanation of how the user may respond to the notification. The notification may include, for example, a URL that links the user to the Web page where the user may authorize, cancel, suspend or modify the payment.

In one alternative, the notification sent to the user can be protected cryptographically. For example, the notification can be encrypted by the bank server 108 or digitally signed by the bank server 108. This ensures that the notification received by the user is genuine.

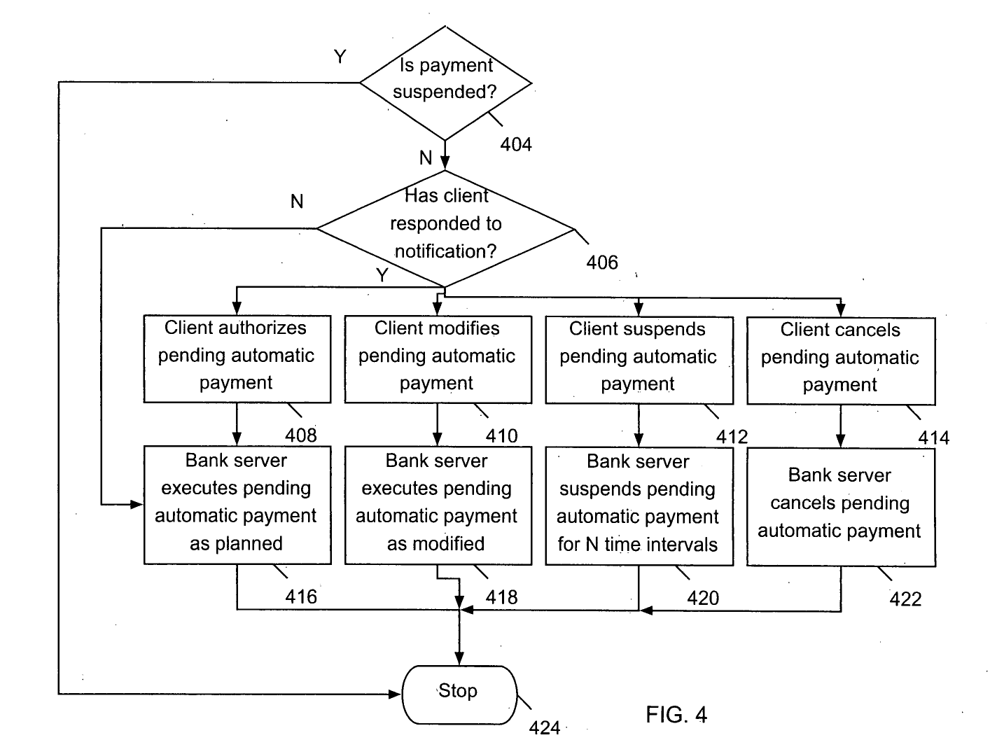

In step 312, the bank server 108 determines how to proceed with the automatic recurring online payment based on the user's response to the notification. The user preferably may respond in a variety of ways, including via email, an instant message, a telephone message, a text message or by interacting with a user interface such as a Web page of the bank server 108. The user may authorize, cancel, suspend or modify the payment via a response (or lack of response) to the notification. In step 314, the bank server 108 executes or does not execute the automatic recurring online payment that was configured in step 304 based on the user's response to the notification. Consequently, control flows back to step 306 where another time interval is allowed to pass before step 308 is executed again. The functions of steps 312 and 314 will now be described in greater detail with reference to FIG. 4.

FIG. 4 is a flowchart depicting the operation and control flow of the verification process of one embodiment of the present invention. The operation and control flow of FIG. 4 provides more detail of the functions of steps 312 and 314 of FIG. 3.

In step 404, the bank server 108 determines whether the current automatic recurring online payment has already been suspended. This may have occurred when the user suspended the automatic recurring online payment for a certain number of payments in a response to a previous notification. If the current automatic recurring online payment has already been suspended, then control flows to step 424. If the current automatic recurring online payment has not been suspended, then control flows to step 406.

In step 406, the bank 108 determines whether the client has responded to the notification. As explained above, preferably the user may respond to a notification via email, an instant message, a telephone message, a text message or by interacting with a user interface such as a Web page of the bank server 108. In one alternative, the user's response can be protected cryptographically. For example, the user's response can be encrypted by the user or digitally signed by the user. This ensures that the user's response received by the bank 108 is genuine.

The user may authorize, cancel, suspend or modify the payment via the response or lack of response to the notification. If the user authorizes the payment, then control flows to step 408. If the user modifies the payment, then control flows to step 410. If the user suspends the payment, then control flows to step 412. If the user cancels the payment, then control flows to step 414.

In step 408, the user has authorized the payment, and thus in step 416 the bank server 108 executes the current automatic recurring online payment as originally planned. In step 410, the user has modified the payment. Preferably, the user may modify any information pertaining to an automatic recurring online payment including a monetary amount of the payment, a source account of the payment, a recipient or payee of the payment, a date of the payment, a time interval between payments, and a monthly date for the payment. In step 418, the bank server 108 executes the current automatic recurring online payment as modified by the user.

In step 412, the user has suspended the payment, and thus in step 420 the bank server 108 suspends the current automatic recurring online payment for one or more intervals, depending on what the user has specified. In step 414, the user has canceled the payment, and thus in step 422 the bank 108 cancels the current automatic recurring online payment. In step 424, the control flow of FIG. 4 stops.

5. Exemplary Web Implementation

FIG. 5 is a screenshot of an exemplary user interface for configuring a recurring automatic online payment. FIG. 5 shows a user interface 500 consisting of a Web browser for viewing a Web page identified by the URL 502, wherein the Web page allows a user to configure a recurring automatic online payment. The Web page is located at the Web site of the bank server 108 and viewing of the Web page can be encrypted using, for example, Secure Socket Layer. This ensures that the user's bank account information is secure.

The Web page includes a drop down menu 504 (or alternatively a text box) for identifying the name of the payee that the user wishes to pay. Also shown is a text field 506 for identifying the payee's account number for the user Text box 508 allows the user to enter the amount to pay. Drop down menus 510 and 512 allow the user to specify how often the payment will occur. Checkbox 514 allows a user to specify whether to be notified of the recurring automatic online payment before it occurs. Text field 516 allows the user to specify how many days before the payment to be notified. The user can specify an email notification with checkbox 518 and specify the email address in text field 520. The user can specify a telephone notification with checkbox 522 and specify the telephone number in text field 524. The user can specify a text message notification with checkbox 526 and specify the address in text field 528.

In text field 530, the user can specify how many days to wait before a default action is taken due to a lack of response by the user to the notification. If checkbox 532 is selected, then the recurring automatic online payment is executed as the default action. If checkbox 534 is selected, then the recurring automatic online payment is executed as the default action only if there are sufficient funds in the user's bank account. If checkbox 536 is selected, then the recurring automatic online payment is not executed as the default action.

A submit button 538 is displayed to allow the user to submit the information in the Web page and create a recurring automatic online payment. A reset button 540 allows the user to clear the information in the Web page and start anew.

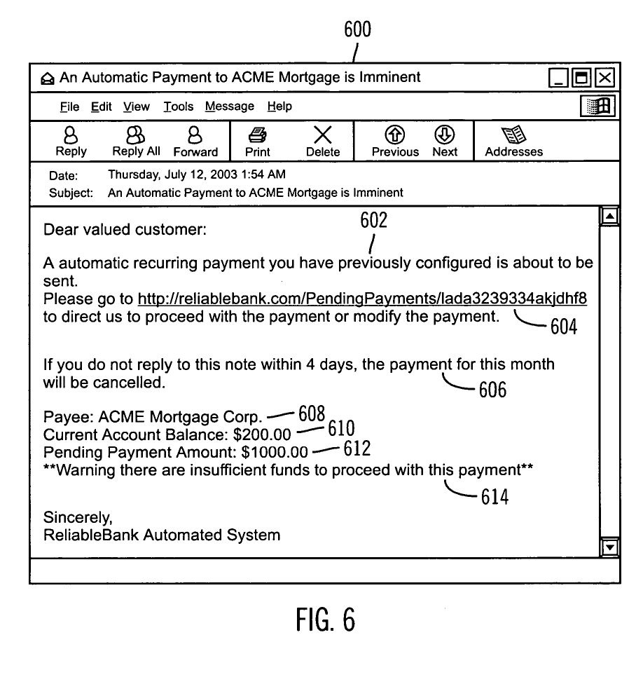

FIG. 6 is a screenshot of an exemplary user interface for viewing a notification of a recurring automatic online payment. FIG. 6 shows a user interface 600 consisting of a window for viewing an email notification regarding a recurring automatic online payment that was sent by the bank server 108. In one alternative, the email viewed in FIG. 6 is protected cryptographically. For example, the email can be encrypted by the bank server 108 or digitally signed by the bank server 108. This ensures that the email received by the user is genuine.

FIG. 6 shows a short message 602 reminding the user about a recurring automatic online payment that was previously configured. Also included in the email is a URL 604 that links the user to a Web page where the user may authorize, cancel, suspend or modify the payment. This is described in greater detail above. FIG. 6 further shows a short message 606 whereby the user is told the default action of the bank server 108 if a response is not received form the user within a specified period of time. Also included is the name of the payee 608, the user's current account balance 610 and the amount of the payment 612. Optionally, also shown is a short message 614 that indicates that the user's current account balance is not sufficient to cover the payment amount 612.

6. Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

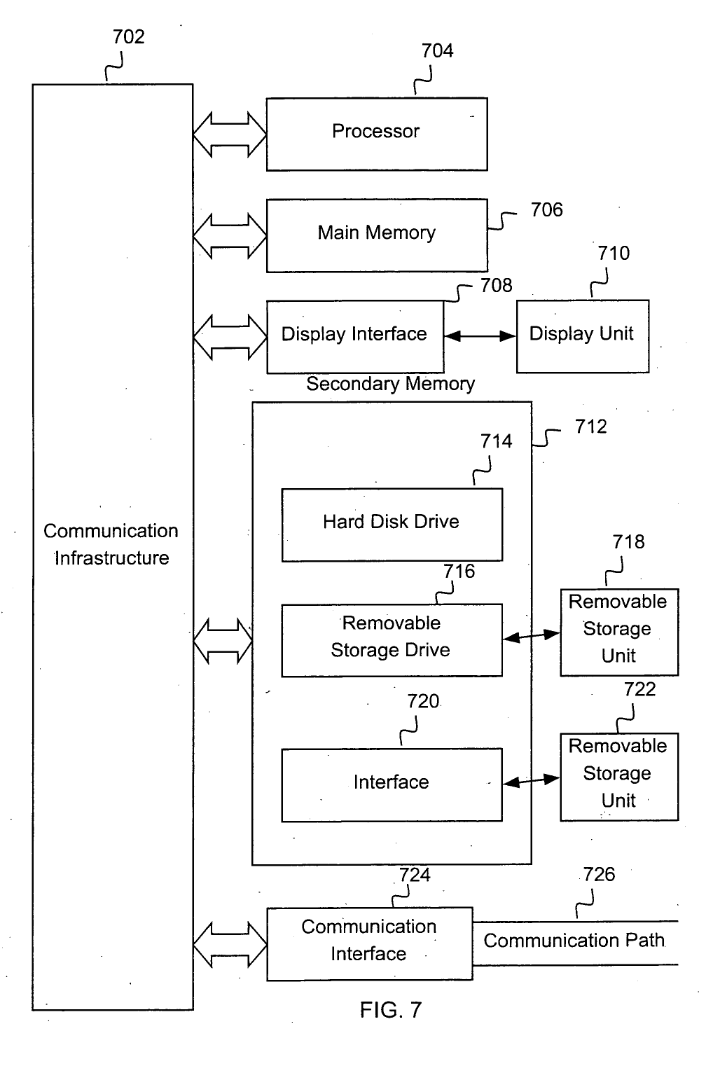

FIG. 7 is a block diagram of a computer system useful for implementing an embodiment of the present invention. The computer system of FIG. 7 includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents, for example, a floppy disk, magnetic tape, optical disk, etc. which is read by and written to by removable storage drive 716. As will be appreciated, the removable storage unit 718 includes a computer usable storage medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for providing automatic recurring online payments, the method comprising the steps of:
receiving, from a user, an automatic recurring online payment configuration;
sending a notification to the user of a pending automatic payment based on the automatic recurring online payment configuration; and
determining whether or not to execute the pending automatic payment based on at least one of a response to the notification received from the user and a lack of a response to the notification from the user.

2. The method of claim 1, wherein the automatic recurring online payment configuration includes a source account for the automatic recurring online payment, a recipient of the automatic recurring online payment, and at least one payment date.

3. The method of claim 1, wherein the notification comprises at least one of an email message and an instant message.

4. The method of claim 1, wherein the determining step comprises the sub-steps of:
receiving the response to the notification from the user; and
if the response from the user authorizes the pending automatic payment, executing the pending automatic payment according to the automatic recurring online payment configuration.

5. The method of claim 4, wherein the determining step further comprises the sub-step of:
if the response from the user modifies the pending automatic payment, executing the pending automatic payment as modified.

6. The method of claim 4, wherein the determining step further comprises the sub-step of:
if the response from the user suspends the pending automatic payment, suspending the pending automatic payment.

7. The method of claim 4, wherein the determining step further comprises the sub-step of:
if the response from the user cancels the pending automatic payment, canceling the automatic recurring online payment.

8. The method of claim 1, wherein in the determining step, if a response to the notification is not received from the user, it is determined to execute the pending automatic payment.

9. The method of claim 1, wherein in the determining step, if a response to the notification is not received from the user, it is determined to suspend the pending automatic payment or cancel the automatic recurring online payment.

10. A computer program product for providing an automatic online payment, the computer program product comprising:
a storage medium readable by a processing circuit and storing instructions for execution by the processing circuit for performing a method comprising the steps of:
receiving, from a user, an automatic recurring online payment configuration;
sending a notification to the user of a pending automatic payment based on the automatic recurring online payment configuration; and
determining whether or not to execute the pending automatic payment based on at least one of a response to the notification received from the user and a lack of a response to the notification from the user.

11. The computer program product of claim 10, wherein the notification comprises at least one of an email message and an instant message.

12. The computer program product of claim 10, wherein the determining step comprises the sub-steps of:
receiving the response to the notification from the user; and
if the response from the user authorizes the pending automatic payment, executing the pending automatic payment according to the automatic recurring online payment configuration.

13. The computer program product of claim 12, wherein the determining step further comprises the sub-step of:
if the response from the user modifies the pending automatic payment, executing the pending automatic payment as modified.

14. The computer program product of claim 12, wherein the determining step further comprises the sub-steps of:
if the response from the user suspends the pending automatic payment, suspending the pending automatic payment; and
if the response from the user cancels the pending automatic payment, canceling the automatic recurring online payment.

15. The computer program product of claim 10, wherein in the determining step, if a response to the notification is not received from the user, it is determined to execute the pending automatic payment.

16. The computer program product of claim 10, wherein in the determining step, if a response to the notification is not received from the user, it is determined to suspend the pending automatic payment or cancel the automatic recurring online payment.

17. A computer system for providing automatic recurring online payments, the computer system comprising:
a receiver receiving, from a user, an automatic recurring online payment configuration;
a transmitter sending a notification to the user of a pending automatic payment based on the automatic recurring online payment configuration; and
a processor determining whether or not to execute the pending automatic payment based on at least one of a response to the notification received from the user and a lack of a response to the notification from the user.

18. The computer system of claim 17,
wherein the response to the notification is received from the user, and
if the response from the user authorizes the pending automatic payment, the processor executes the pending automatic payment according to the automatic recurring online payment configuration.

19. The computer system of claim 18,
wherein if the response from the user modifies the pending automatic payment, the processor executes the pending automatic payment as modified.

20. The computer system of claim 18,
wherein if the response from the user suspends the pending automatic payment, the processor suspends the pending automatic payment, and
if the response from the user cancels the pending automatic payment, the processor cancels the automatic recurring online payment.
